(19) United States
(12) Patent Application Publication
(10) Pub. No.: US 2013/0087430 A1
(43) Pub. Date: Apr. 11, 2013

(54) MATERIAL HANDLING STATION

(71) Applicants: Harry V. KIRK, Acworth, GA (US); Bryan Carbon, Woodstock, GA (US); Tommy W. Bhonn, Marietta, GA (US)

(72) Inventors: Harry V. KIRK, Acworth, GA (US); Bryan Carbon, Woodstock, GA (US); Tommy W. Bhonn, Marietta, GA (US)

(73) Assignee: Kirk-Rudy, Inc., Woodstock, GA (US)

(21) Appl. No.: 13/253,623

(22) Filed: Oct. 5, 2011

(51) Int. Cl. B65G 47/244; B65G 17/24

(52) U.S. Cl. 198/411; 198/779

(57) ABSTRACT

A system for handling various items with increased functionality and decreased mechanical complexity is disclosed. The system uses a plurality of rollers mounted between pairs of drive chains or belts to impart a driving force to the items to be moved. The drive chains or belts can be reversible to change the direction of travel. The angle of attack, α, of the rollers can be adjusted between a negative angle and a positive angle by changing the phase between the drive chains or belts to change a component of the driving force. The rollers can be braked to increase a component of the driving force. The spin of the rollers can be changed with a roller belt to change another component of the driving force.

### BACKGROUND OF THE INVENTION

1. Field of the Invention

Embodiments of the present invention relate to a system and method for moving and turning packages for use in, for example and not limitation, shipping, manufacturing, and baggage handling. Specifically, embodiments of the present invention relate to a chain driven, helical roller system for both translating and rotating items in an efficient and flexible manner.

2. Background of Related Art

The ability to move objects in both translation and rotation can be useful in a variety of applications. When handling packages in the shipping industry, for example, it may be necessary to rotate packages so that they can be easily loaded onto a plane or truck, or simply to ensure the shipping labels face a reader. On a manufacturing assembly line, it can be desirable to rotate and translate items to enable, for example, parts on the front of an engine to be assembled and then rotated to enable parts on the rear of the engine to be assembled.

Equipment exists to facilitate both translation and rotation on the same platform. In some instances, this equipment can comprise a platform with a plurality of roller clusters including, for example, helical roller assemblies (“heli-rollers”). As shown in FIG. 1, the heli-roller 30, as disclosed in U.S. Pat. No. 6,360,865, to FMC Corporation, generally comprises an outer frame 36 with multiple rollers 41 mounted in the frame 36 at an angle. A plurality of heli-rollers 30 can then be mounted on one or more common drive shafts to rotate the heli-rollers in one or both directions.

As shown in FIG. 2, shipping companies, in this case Federal Express, often use platforms 200 comprising multiple quadrants 210, 215, 220, 225 of heli-rollers 205 to provide translation and rotation for packages placed on the platform. This can be useful, for example, to rotate a large shipping container into the proper orientation and then load it into the cargo hold of a plane. In each quadrant, a plurality of heli-rollers 205 is mounted on one or more common shafts. The heli-rollers 205 are mounted at an angle, generally 45 degrees, to the direction of travel such that, depending on the relative direction of rotation of rotation, translation, rotation, or both. In other words, rotating the heli-rollers 205 in the first quadrant and second quadrants 210, 215 in the same direction tends to cause translation in the direction of rotation, while rotating the first and second quadrants 210, 215 in opposite directions tends to cause rotation.

Referring back to FIG. 1, a drawback of this configuration, however, is that the angle of the rollers 41 is fixed during manufacture. In other words, because the rollers 41 are rigidly mounted in the frame 36, the angle of the rollers 41 with respect to the direction of travel is determined purely by how the assembly 205 is mounted on the drive shaft. As shown in FIG. 2, therefore, four quadrants 210, 215, 220, 225 with a fairly large number of heli-rollers in each are required to provide translation and rotation in all directions. This limitation results in unnecessarily large, heavy, and expensive machines.

What is needed, therefore, is a more efficient means for providing rotation and translation to objects as part of a transportation system such as, for example and not limitation, an assembly line, conveyor system, or package distribution system. It should provide full translation and rotation of objects while minimizing complexity. It is to such a device that embodiments of the present invention are primarily directed.

### SUMMARY OF THE INVENTION

Embodiments of the present invention relate to a system and method (“system”) for moving and turning packages for use in, for example and not limitation, shipping, manufacturing, and baggage handling. Specifically, embodiments of the present invention relate to a chain driven, helical roller system for both translating and rotating items in an efficient and flexible manner.

The system can comprise a plurality of drive rollers pivotally connected on both ends to one or more pairs of drive chains or belts. The drive chains can be driven in either direction and can have adjustable phase. Adjusting the phase of one drive chain in the pair can adjust the angle of the roller with respect to the direction of travel. In some embodiments, the drive chains can be belts (e.g., toothed, cogged, or v-belts).

Embodiments of the present invention can comprise a drive system comprising a pair of drive chains, wherein each chain can comprise a first end and a second end. The system can further comprise a plurality of drive pulleys disposed at the first ends and the second ends of each drive chain for supporting and driving the drive chains and a plurality of rollers, each with a first end pivotally coupled to a first drive chain and a second end pivotally coupled to a second drive chain. In some embodiments, the angle of the rollers with respect to the drive chains can be adjusted between a positive angle and a negative angle.

In some embodiments, each of the plurality of rollers can further comprise a roller body and a roller axle disposed through the roller body at the axis of rotation. The roller axle can further comprise one or more sockets for pivotally coupling the roller axle to the drive chains. In some embodiments, the angle of the rollers can be adjusted between approximately −60 degrees and +60 degrees. In a preferred embodiment, the angle of the rollers can be adjusted between approximately −45 degrees and +45 degrees.

Embodiments of the present invention can further comprise a roller brake or belt. The roller brake can have a first, engaged position and a second, disengaged position. In the engaged position, the rollers can roll forward in the same direction as the drive chains. In the disengaged position, on the other hand, the rollers can free wheel. In other embodiments, the system can comprise a roller belt for rolling the rollers forward or backward.

The system can further comprise a first axle for mounting the drive pulleys on the first end of the drive chains and a second axle for mounting the drive pulleys on the second end of the drive chains. In some embodiments, the system can further comprise one or more drive motors for driving one or more of the drive pulleys. In some embodiments, the drive motors can be reversible. In still other embodiments, the drive motors can be directly coupled to the axles or can be indirectly coupled to the axles using, for example, a belt or chain.

Embodiments of the present invention can also comprise an enclosure comprising at least a top surface, and two or more drive systems. Each drive system can comprise a pair of drive chains, each chain can comprise a first end and a second end, a plurality of drive pulleys disposed at the first ends and the second ends of each drive chain for supporting and driving the drive chains, a plurality of rollers, each with a first end pivotally coupled to a first drive chain and a second end pivotally coupled to a second drive chain, and one or more drive motors for driving the drive chains.

In some embodiments, the drive motors from each of the two or more drive system can be run in opposite directions at the same time. The drive pulleys can be slip mounted on one or more axles to enable the phase between the drive chains to be adjusted to adjust the angle of the rollers.

These and other objects, features and advantages of the present invention will become more apparent upon reading the following specification in conjunction with the accompanying drawing figures.

### BRIEF DESCRIPTION OF THE DRAWINGS

FIG. 1 depicts a conventional heli-roller assembly.

FIG. 2 depicts a conventional package handling loader used in the shipping industry.

FIG. 3 depicts a package handling system, in accordance with some embodiments of the present invention.

FIG. 4 depicts a drive system pair, in accordance with some embodiments of the present invention.

FIG. 5 depicts a motor drive system, in accordance with some embodiments of the present invention.

FIG. 6a depicts a single drive system, in accordance with some embodiments of the present invention.

FIG. 6b depicts a detailed view of a pivoting roller attachment system, in accordance with some embodiments of the present invention.

FIG. 6c depicts a master link and clip retainer, in accordance with some embodiments of the present invention.

FIGS. 6d-6f depict the variable geometry of the rollers on the drive system, in accordance with some embodiments of the present invention.

FIG. 7a depicts a roller brake system, in accordance with some embodiments of the present invention.

FIG. 7b depicts a roller belt system, in accordance with some embodiments of the present invention.

FIGS. 8a-8d depict various drive forces resulting from different roller angles and roller spin, in accordance with some embodiments of the present invention.

FIGS. 9a-9d depict the translational and rotational forces imparted by two drive systems, in accordance with some embodiments of the present invention.

FIG. 10 depicts multiple drive systems assembled to from a large package handling system in accordance with some embodiments of the present invention.

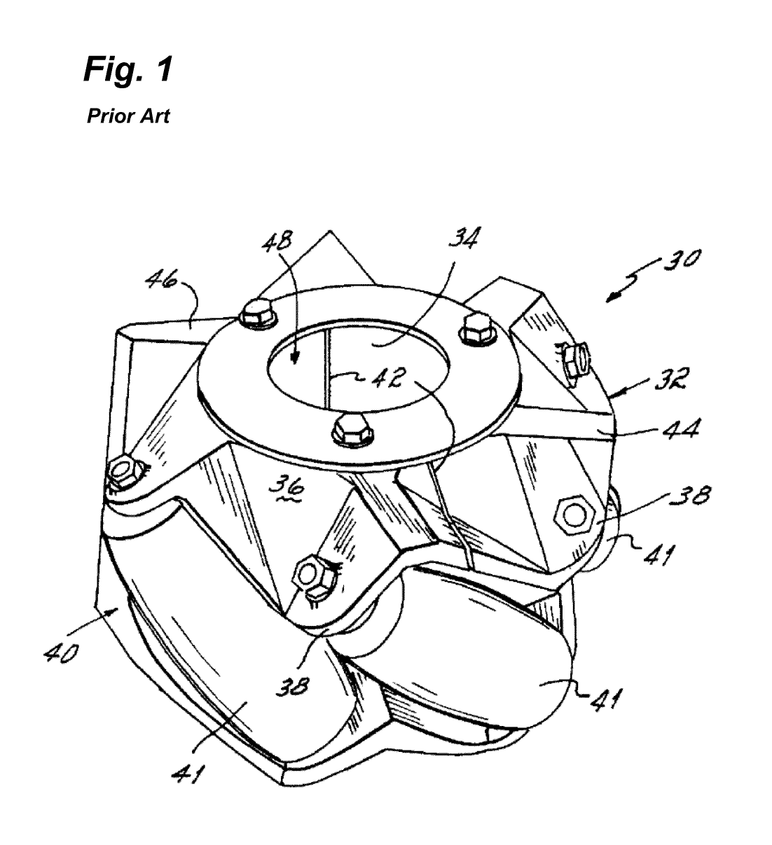

### DETAILED DESCRIPTION OF THE INVENTION

Embodiments of the present invention relate to a system and method (“system”) for moving and turning packages for use in, for example and not limitation, shipping, manufacturing, and baggage handling. Specifically, embodiments of the present invention relate to a chain driven, helical roller system for both translating and rotating items in an efficient and flexible manner.

The system can comprise a plurality of drive rollers pivotally connected on both ends to one or more pairs of drive chains or belts. The drive chains can be driven in either direction and can have adjustable phase. Adjusting the phase of one drive chain in the pair can adjust the angle of the roller with respect to the direction of travel.

To simplify and clarify explanation, the system is described below as a system for moving packages or containers during shipping and/or sorting operations. One skilled in the art will recognize, however, that the invention is not so limited. The system can also be deployed anytime moving and/or rotating items is desirable such as, for example and not limitation, on conveyor belts and assembly lines and in warehouses.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed, for example, after the time of the development of the invention. Any dimensions listed in the various drawings are for illustrative purposes only and are not intended to be limiting. Other dimensions and proportions are contemplated and intended to be included within the scope of the invention.

As mentioned above, several problems exist with conventional package moving and rotating equipment. Due to the limitations on movement caused by the conventional heli-roller configuration, current package handlers are large, expensive, and heavy. In addition, these package handlers use a plurality of proprietary parts making maintenance difficult and expensive.

Embodiments of the present invention, therefore, relate to a system and method for providing improved package handling with reduced mechanical complexity. The system can be modular to provide tailored functionality. In some embodiments, the system can provide rotation in both directions (i.e., clockwise or counter-clockwise) and can provide translation in any direction (i.e., forward backward, left, right, and combinations thereof).

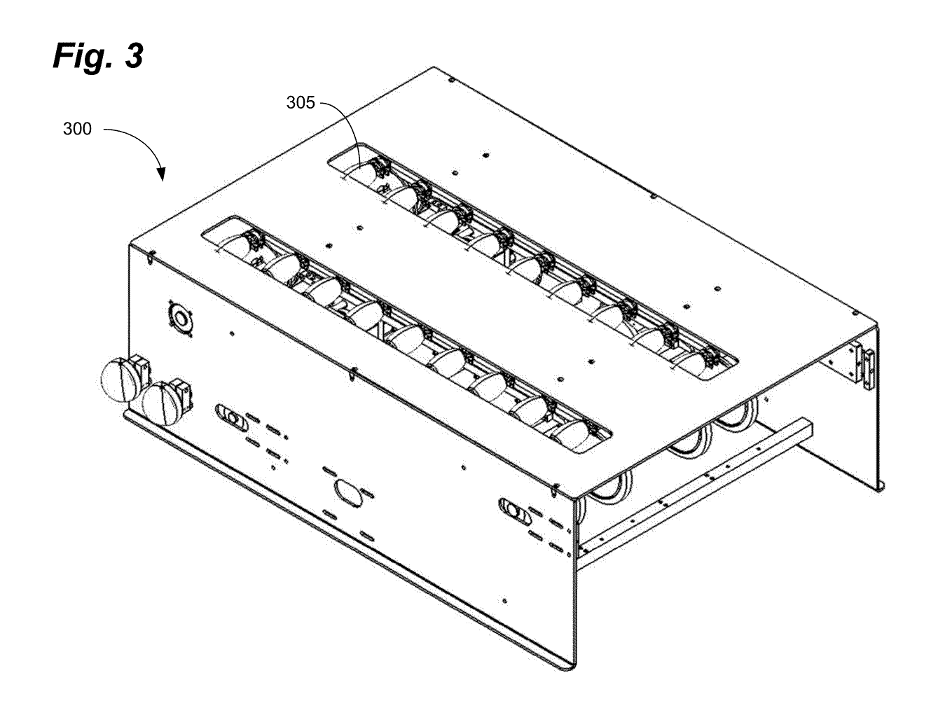

As shown in FIG. 3, embodiments of the present invention can comprise a modular package handling system or unit 300 comprising one or more sets of driven rollers 305 for moving items across a top surface or table 310. As discussed below, the driven rollers 305 can move in both directions (i.e., forward and backward) across the table and their angle can be adjusted to change their driving force. Each unit can provide translation in multiple directions and rotation in both directions (i.e., clockwise and counterclockwise). Multiple units 300 can be assembled to provide additional flexibility and/or capacity.

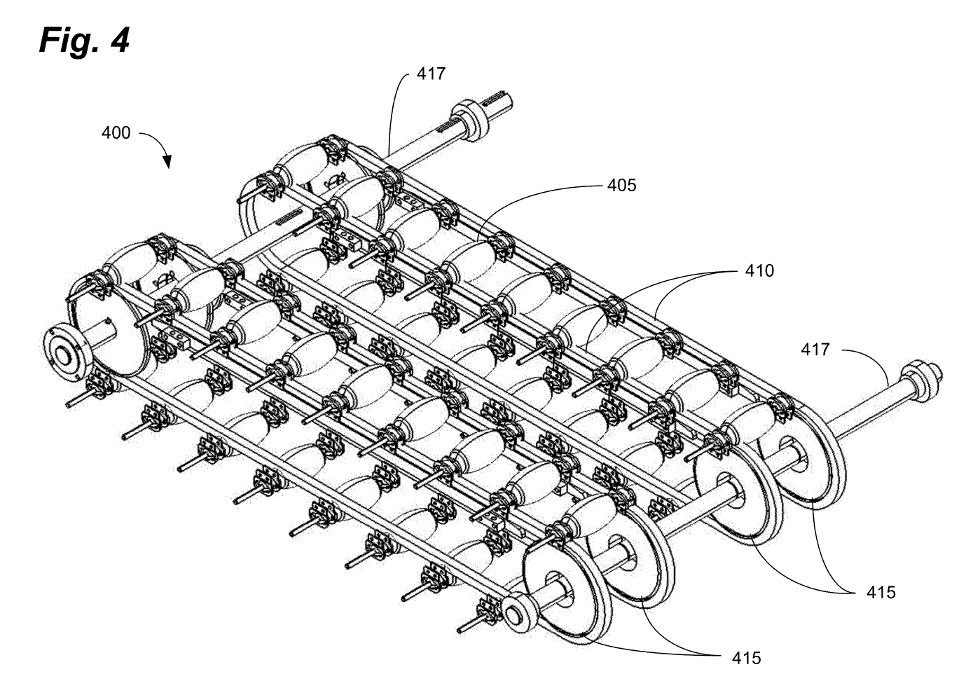

As shown in FIG. 4, each unit 300 can comprise one or more drive systems 400. Each drive system can comprise a plurality of rollers 405 pivotally coupled to two or more drive chains 410. While referred to and shown herein as a chain, the drive chains 410 can comprise many suitable materials including, for example and not limitation, cogged belts, toothed belts, ribbed belts, or rope. In a preferred embodiment, the drive chains 410 are roller-type chains (e.g., similar to a bicycle chain).

Each drive system 400 can comprise two or more chains 410 traveling over drive pulleys 415. The drive pulleys 415 can be mounted on one more axles 417. In a preferred embodiment, each drive system 400 can comprise two chains with a plurality of rollers 405 disposed therebetween. In some embodiments, based on, among other things, the length of the chains 410 and the required load capacity, the drive system 400 can further comprise one or more idler pulleys disposed along the length of the chains 410. The idler pulleys can provide additional support for the chains 410. In addition, the idler pulleys can help maintain the alignment of the chains against, for example, side loading.

The drive pulleys 415 can be driven, directly or indirectly, by any suitable means 425 for providing rotational energy to the drive pulleys 415 and/or axles 417. In some embodiments, such as in a conveyer system, for example, the drive pulley 415 or axle 417 can be driven off a common belt, shaft, or other drive system for driving part, or all, of the conveyor system. In other embodiments, the drive pulleys 415 can also be driven by a suitable motor such as, for example and not limitation, a hydraulic or pneumatic motor.

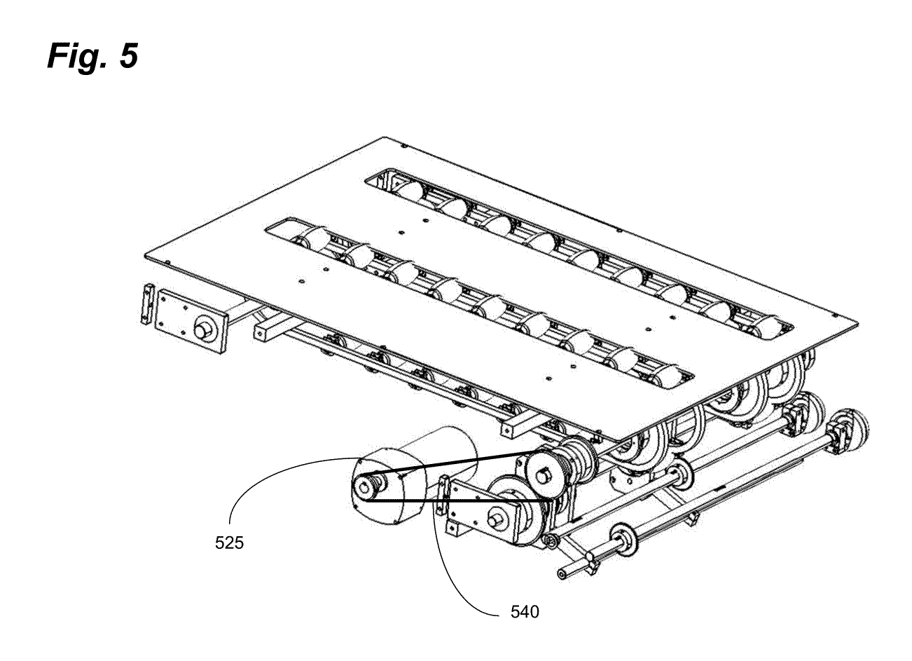

As shown in FIG. 5, in a preferred embodiment, the drive pulleys 415 can be driven by one or more electric motors 525. As shown, the drive pulleys 415 can be driven by a belt or chain 540 driven by the electric motor 525. The belt 540 can be any suitable drive means including, but not limited to, a v-belt, a toothed belt, or a chain. In other embodiments, the drive pulleys 415 can be directly driven by the motor 525 (i.e., the motor can be mounted on the axle 417 or can be driven indirectly through a transmission or other means. In some embodiments, the linkage between the motor 525 and the drive pulleys 415 can include a clutch to prevent damage to the motor 525 or pulley 415 in the event of a jam or other mechanical failure.

In a preferred embodiment, the motor 525 (or other drive means) is reversible. In some embodiments, this can be achieved, for example, simply by providing reversible drive motors 525. In other embodiments, this can be achieved using a reversible transmission or clutch. In this configuration, the drive chains 410 can be driven in forward and reverse, which, as discussed below, enables embodiments of the present invention to provide full rotational and translational control of the package.

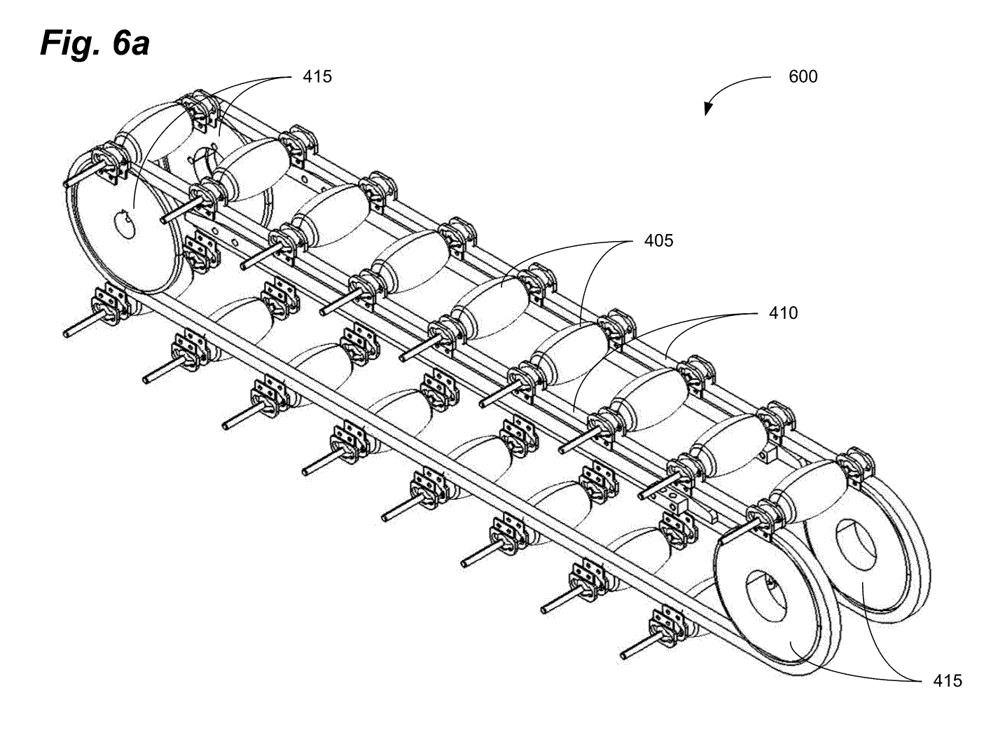

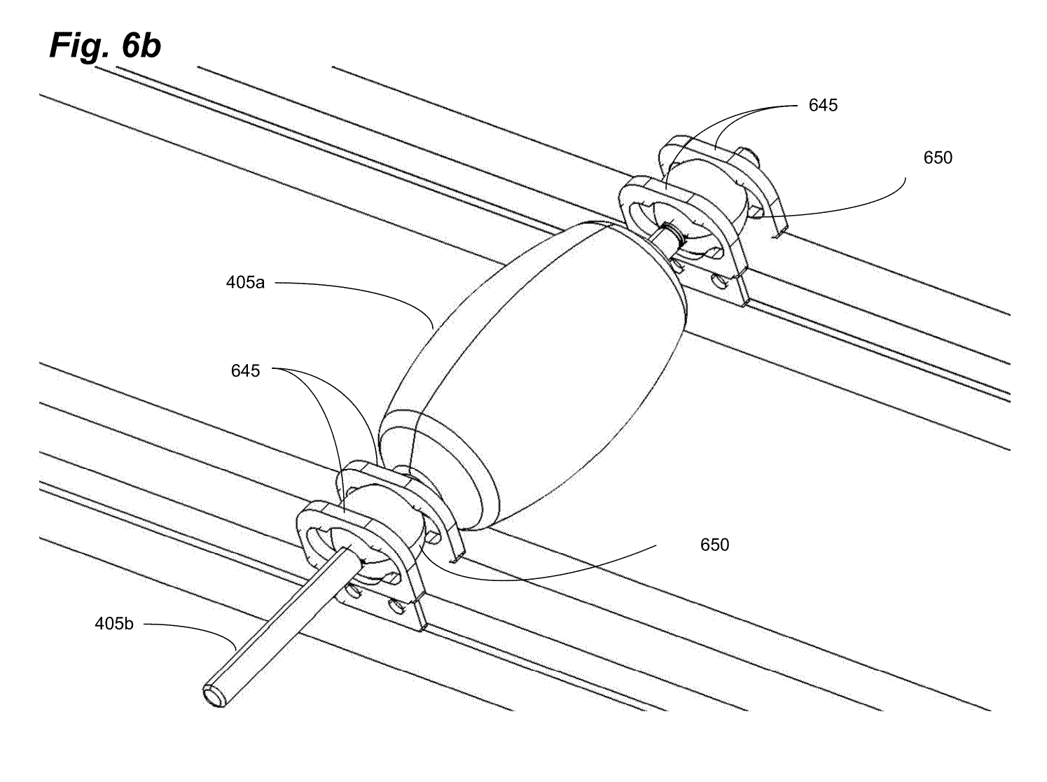

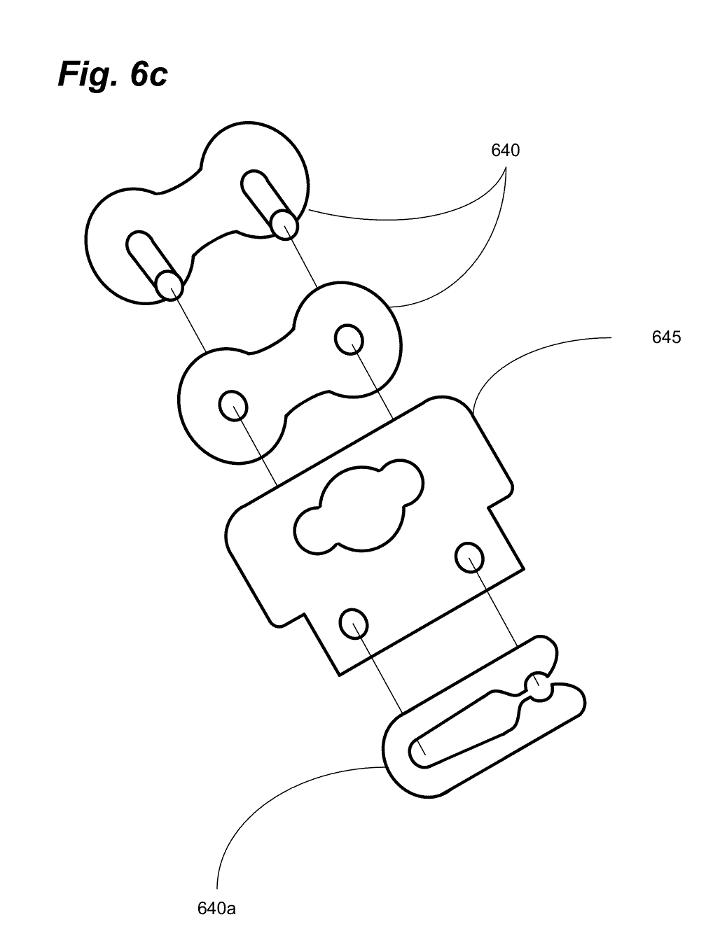

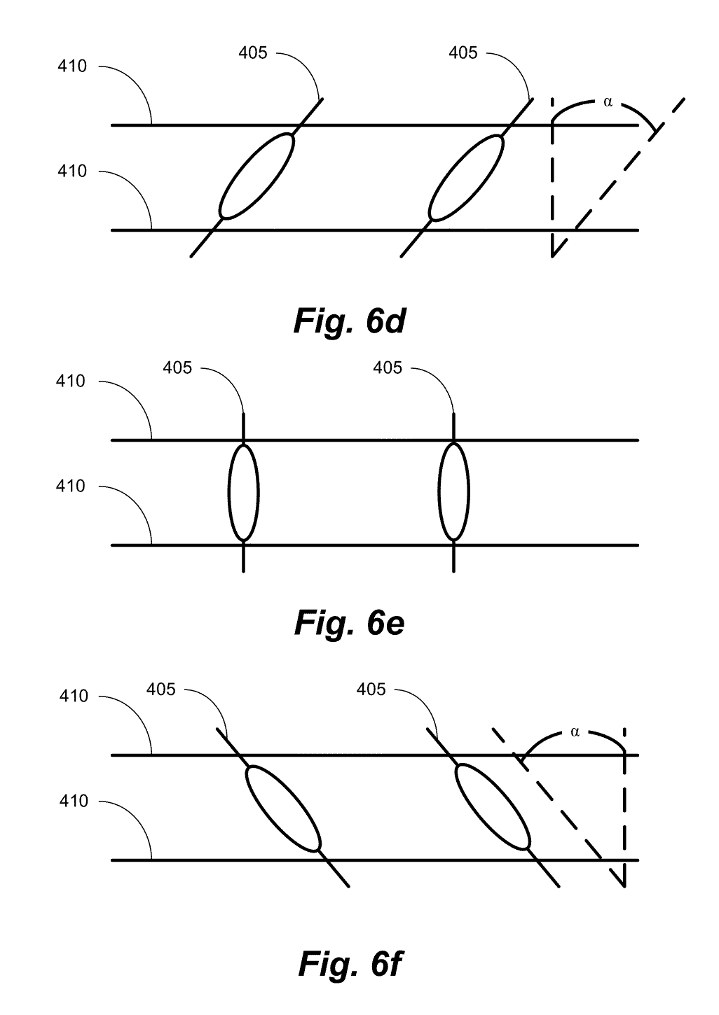

As shown in FIG. 6a, and in detail in FIG. 6b, in some embodiments, the plurality of rollers 405 can be pivotally attached between each pair of drive chains 410. In some embodiments, the rollers 405 can comprise a roller body 405a and an axle 405b. In other embodiments, the roller body 405a and axle 405b can be integrally formed (i.e., cast, molded, or machined from one part).

The rollers 405 can be attached to the chains using many suitable methods provided the rollers can pivot with respect to the chains. The axles 405b can be affixed to the chains using a mount comprising a flexible material such as, for example and not limitation, rubber or plastic. In this configuration, the axle 405b can flex within the mount to enable the angle of the roller 405 to be adjusted.

In a preferred embodiment, the rollers 405 are attached to the chains 410 using clips 645 attached to the chains 410. The clips 645 can be riveted, crimped, or otherwise attached to the chains 410 at regular or irregular intervals. In some embodiments, the clips 645 can be integral to the links in the chains 410. In other embodiments, as shown in FIGS. 6b and 6c, the clips 645 can be attached to the chains 410 using “master” links 640. In other words, short sections of the chains 410 can be assembled using master links 640 that trap a portion of the clip 645 between the master link 640 and the chain 610. In some embodiments, the master link 640 can be crimped or peened onto the chain 410. In other embodiments, the master link 640 can comprise a removable retaining clip 640a.

In some embodiments, the roller axle 405b can further comprise one or more sockets 650. The sockets 650 can be many shapes such as, for example and not limitation, cylindrical or conical that enable to rollers 405 to pivot with respect to the chains 410. In a preferred embodiment, the sockets 650 are substantially spherical to enable a large range of motion within the clips 645.

The sockets 650 can enable the axle 405b to be pivotally coupled to the chain 410 via the clips 645. In some embodiments, the clips 645 can be installed on one or both sides of the drive chains 410. In other words, in some embodiments, the clips 645 can engage both sides of the sockets 650 to retain the axles 405b to enable the roller 405 to pivot with respect to the chains 410. In other embodiments, the clips 645 can be installed only on the insides of the chains 410, such that the rollers 405 are retained by the length of the axle 405b. In some embodiment, the position of the sockets 650 on the axle 405b can be adjusted to properly align the rollers 405 and the clips 645.

The rollers 405 can pivot over a broad range of angles with respect to the drive chains 410. In some embodiments, the angle of attack α of the rollers can be adjusted approximately ±60 degrees. In a preferred embodiment, α can be adjusted from +45 degrees (FIG. 6d) to straight (FIG. 6e) to −45 degrees (FIG. 6f). As discussed below, a affects the driving force imparted by the rollers 405 to the package. α can be adjusted by changing the phase between the drive chains 410. In other words, in FIG. 6d, the top drive chain 410 leads the bottom drive chain 410 (as shown). In FIG. 6e, on the other hand, the top and bottom drive chains 410 are in phase. Finally, in FIG. 6f, the bottom drive chain 410 leads the top drive chain 410.

Referring back to FIG. 4, providing phase adjustment for the drive chains 410 can be achieved in a number of ways. In some embodiments, the drive pulleys 415 can be mounted on a common axle 417 and can have a slip fit with set screw. In this manner, the relative position of one drive pulley 415 with respect to the other can be changed forward or backward. In other embodiments, the drive pulley 410 can be mounted on separate angles and can be driven by separate motor 525. In this configuration, phase change between the drive chains 410 can be effected by changing the phase between the motors 525. In still other embodiments, one or more of the drive pulleys 410 or axles 417 can be fitted with a solenoid system, similar to systems used for variable valve timing in automotive applications (e.g., BMW's VANOS system), to change the phase between the drive chains 410. Of course, other means including, but not limited to, electrical, mechanical, electromechanical, hydraulic, or pneumatic means could be used and are contemplated herein.

Due to their variable geometry, in some embodiments, the axles 405b can provide variable length. In other words, because the rollers 405 can be pivoted from a negative angle of incidence to a positive angle of incidence, the axle 405b goes from fully extended (at maximum negative angle) to fully retracted (when the roller is perpendicular to the chains 410) to fully extended (at maximum positive angle).

In some embodiments, therefore, the sockets 650 can be slideably engaged with the axles 405b with each socket 650 retained between two clips 645. In this manner, as the axle 405b articulates from a negative angle to a more positive angle (and vice versa); the axle 405b can slide within the sockets 650 as necessary. In other embodiments, the axle 405b and sockets 650 can be integrally formed and the axles 405b can be of a multi-piece design. In this configuration, a tensioning member (e.g., a spring, bungee cord, rubber band, etc.) can be disposed between the two axle 405b halves to provide inward tension. As the axle 405b articulates its length is variable as the tensioning means expands and retracts. In this configuration, it may be desirable to provide clips 645 only in the insides of the chains 410 as the tensioning means can retain the sockets 650 in the clips 645.

In some embodiments, the roller body 405a can rotate freely with respect to the axle 405b. To this end, in some embodiments, the roller body 405a and/or axle 405b can further comprise, for example, plain or roller bearings to decrease friction. In other embodiments, the roller body 405a and axle 405b can be fixed with respect to each other, and the axle 405b can rotate within the clip 645.

A single drive chain set 600 is depicted in FIG. 6a. As shown, each set 600 can comprise a plurality of rollers 405 pivotally coupled to a pair of chains 410. In a preferred embodiment, the phase between the chains 410 can be adjustable. In other words, the relative position of one, or both, chains 410 can be changed. This can enable the positive of the rollers 405 with respect to the direction of travel, which, as discussed below, changes the driving force provided by the rollers.

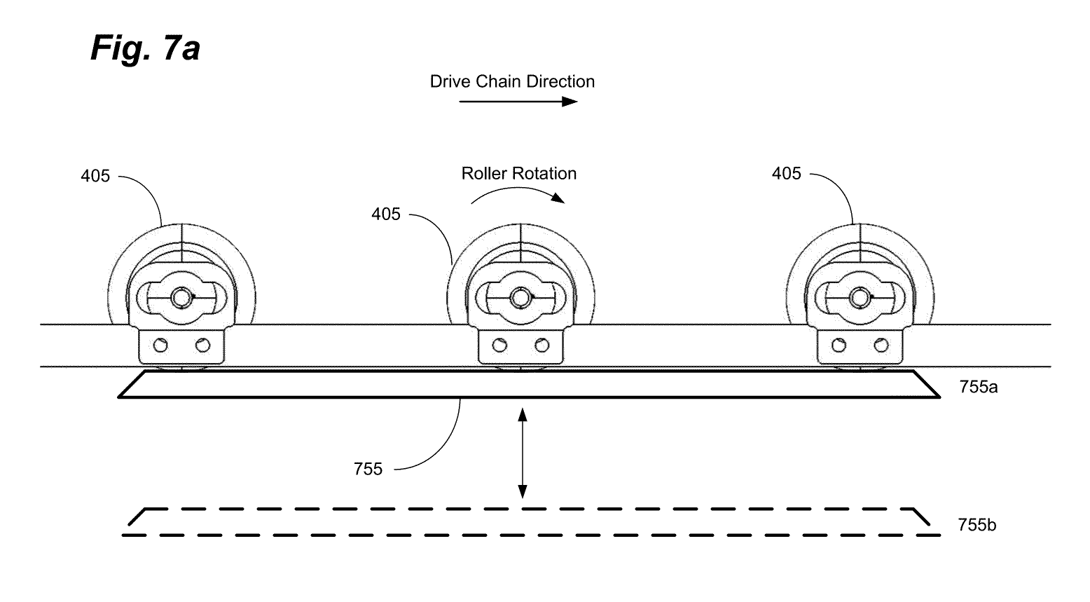

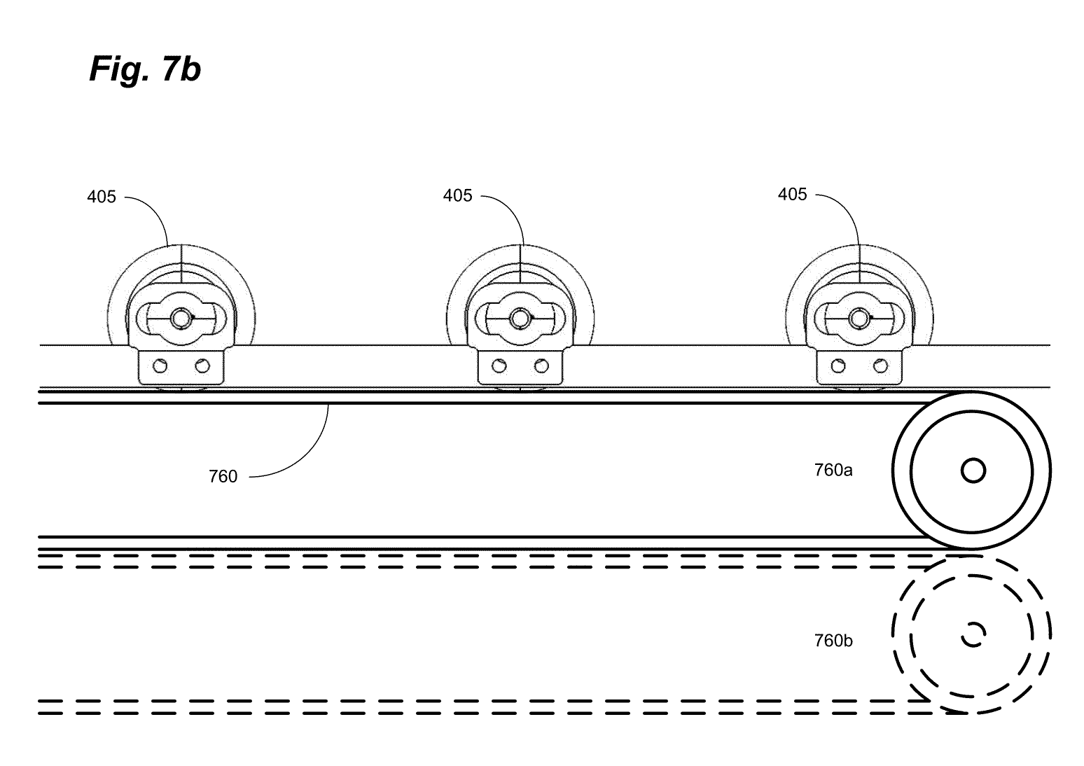

In still other embodiments, as shown in FIG. 7a, each drive chain set 600 can further comprise one or more brakes 755. The brake 755 can have a first engaged position 755a and second, disengaged position 755b. In the disengaged position 755b, the driving force imparted to the package by the rollers 405 is reduced somewhat. Each brake 755 can apply to one, several, or all of the rollers 405. As discussed below, increasing or decreasing the number of rollers 405 onto which the brake(s) 755 are applied can increase or decrease the driving force imparted by the rollers 405 to the package. In other words, maximum force is applied when all of the rollers 405 are braked and vice-versa.

The rollers 405 in the unbraked 755b, or “free-wheeling,” position can be useful in areas where, for example, the packages must turn or there are back-ups that require some slippage. In the engaged position 755a, on the other hand, the roller 405 is rolling in the direction of travel increasing the driving force imparted to the package.

In yet other embodiments, as shown in FIG. 7b, each drive chain set 600 can further comprise one or more roller belts 760. The roller belt 760, like the brake 755, can be used to control the rotation of the rollers 405. When the belt 760 is engaged 760a and is driven at the same speed and in the same direction as the chains 410, for example, the rollers 405 are held still (i.e., they have no independent rotation). If the belt 760 is driven in the opposite direction from the chains 410, on the other hand, the rotation of the rollers on the direction of travel is increased. Finally, if the belt 760 is driven in the direction of travel, but at a higher speed, the rollers 405 tend to rotate backwards (i.e., opposite the direction of travel of the chains 410). Like the brake 755, in some embodiments, the belt 760 can be moved down away 760b from the rollers 405 to enable the rollers 405 to free wheel. Also like the brake 755, in some embodiments, one or more belts 760 can be used on one or more groups of rollers 405 to control the driving force.

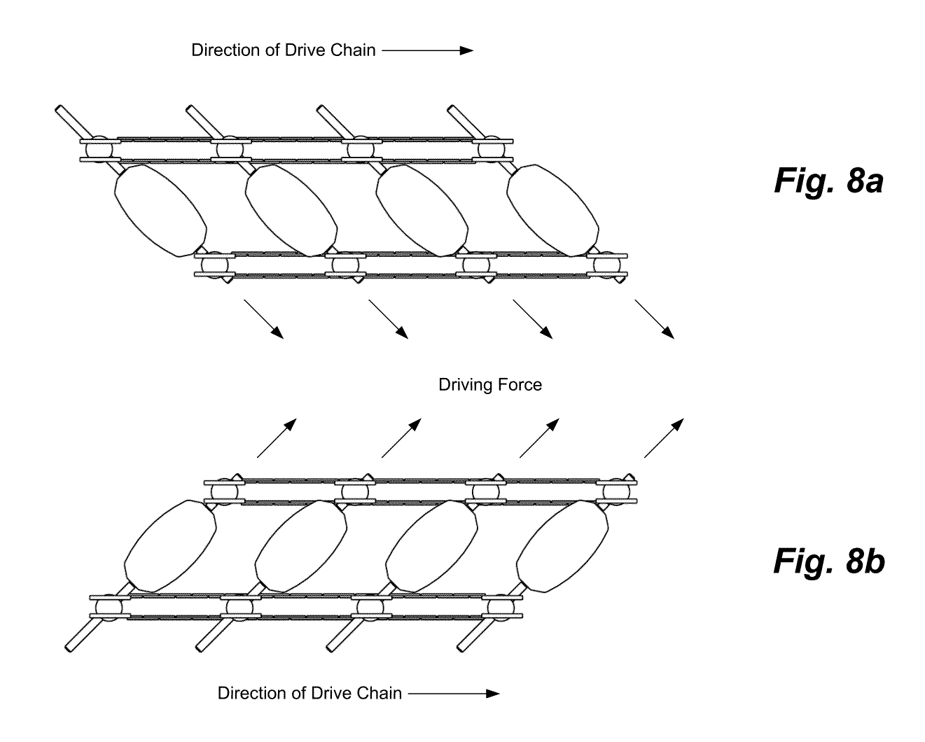

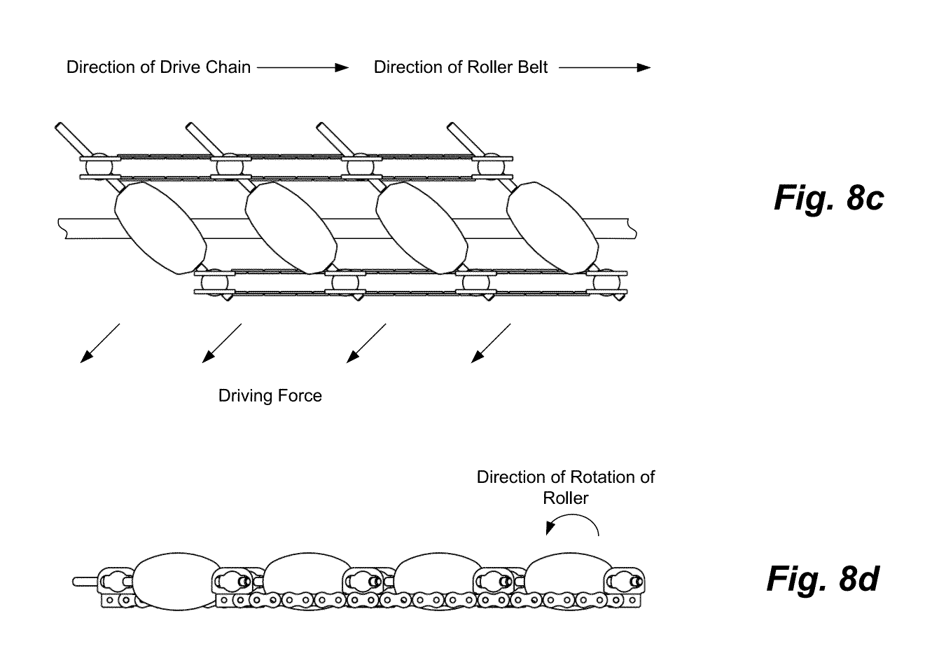

As shown in FIGS. 8a and 8b, the direction of the driving force created by the rollers 405 can be changed by changing the angle of the rollers 405. When the rollers 405 are placed at a positive angle and the drive chains are driven forward, therefore, as shown in FIG. 8a, the resultant driving force is forward and right. When the rollers 405 are placed at a negative angle and the drive chains 410 are driven forward, on the other hand, as shown in FIG. 8b, the resultant driving force is forward and left. This is true with the brake 755 engaged or disengaged; however, with the brake 755 engaged, the driving force is increased as roller 405 slippage on the package is reduced.

The direction of the driving force created by the rollers 405 can also be changed by changing the direction of rotation of the rollers using the roller belt 760. As mentioned above, and shown in FIGS. 8c-8d, driving the roller belt 760 in the same direction as, but at a higher speed than, the drive chains 410 causes the rollers 405 to roll backwards with respect to the direction of travel. In this configuration, therefore, the driving force when the rollers 405 are at a positive angle and the drive chain is moving forward is a driving force back and right.

Without describing every combination and permutation, one skilled in the art can see that providing adjustable roller 405 angle, chain 410 drive direction, and roller belt 760 direction can provide translation is substantially any direction in the two dimensional plane of the top 310 of the unit 300. The driving force imparted to the package from the rollers 405 can also be increased by applying a brake 755 to one or more of the rollers 405 to reduce slippage therebetween.

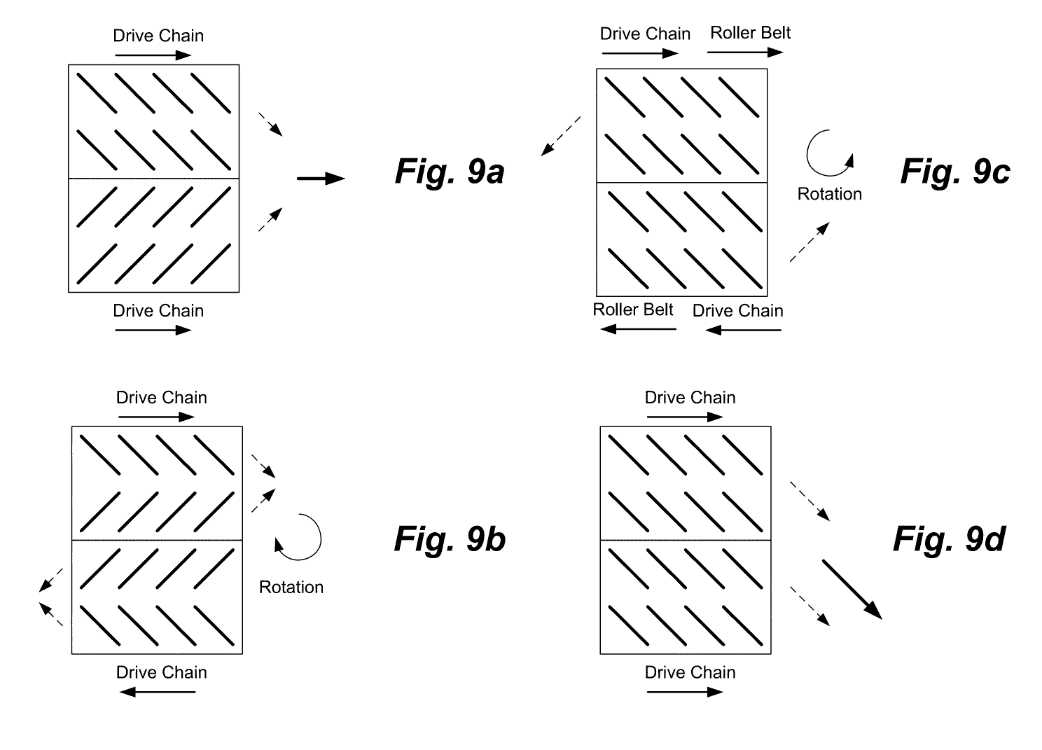

As discussed above, translation in any direction in the two-dimensional plane of the top 310 of the unit 300 can be provided by a single unit 300 by controlling drive chain 410 direction, roller 405 angle, and roller 405 rotation. In other embodiments, as shown in FIGS. 9a-9d, however, multiple units 300 can be combined to provide both translation and rotation.

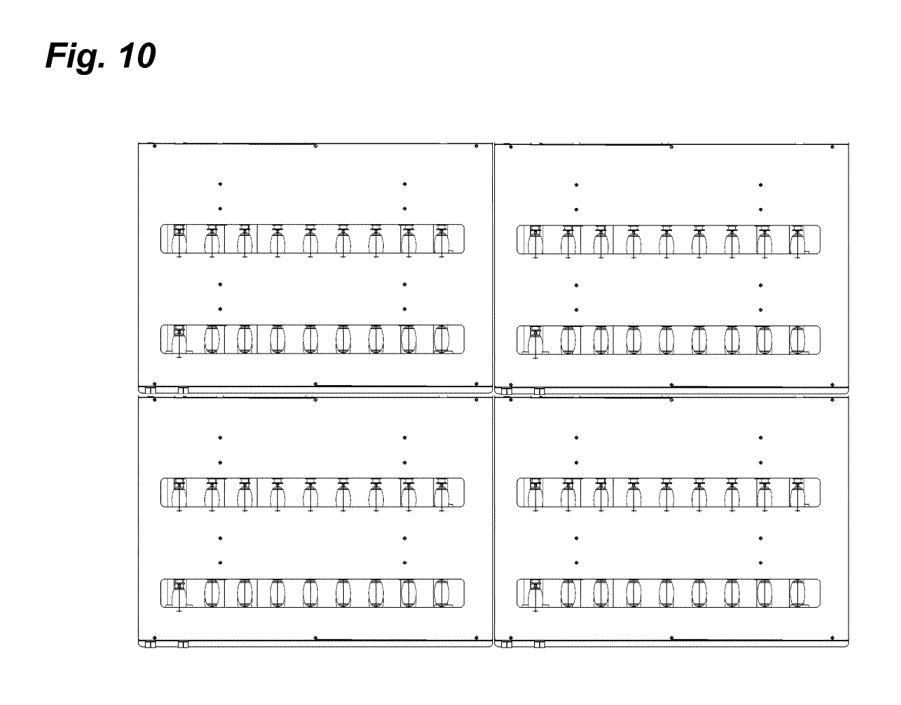

Full translation and rotation can be provided with two units, for example, simply by running the drive chains 410 in opposite directions to create rotation and then running the drive chains 410 in the same direction to create translation. Rotation and translation can be created at the same time by, for example, running both drive chains 410 forward, but rotating one set of rollers 405 backwards with the roller belt 760 to create rotation. Several examples of translation and rotation are depicted in FIGS. 9a-9d. As shown in FIG. 10, due to their modular nature, four or more units 300 can be assembled to provide, for example, larger package control or additional weight capacity.

Embodiments of the present invention, therefore, provide a modular, conveyor-type system with increased direction control and decreased complexity. The ability to change the direction of the drive chains 410, the angle of the rollers 405, and the ability to engage or disengage a brake 755 and/or roller belt 760 provides an unexpectedly broad range of control over a package as it traverses the top 310 of the unit 300.

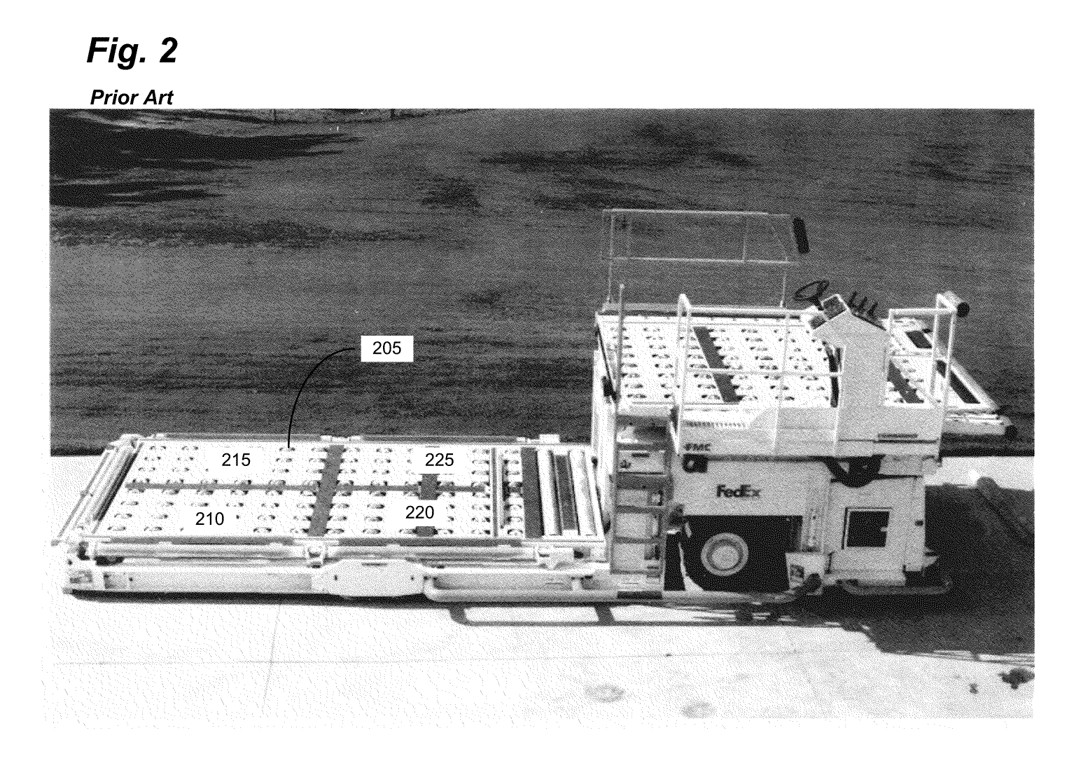

The system 300 can be used in a variety of applications. The system 300 can be used, for example, to update or replace current package handling equipment. See, FIG. 2. Using conventional heli-roller technology, four modules are required on each platform to provide full rotation and translation control. Embodiments of the present invention, on the other hand, achieve the same functionality with only two. The system 300 can also be used for package sorting, for example, to ensure that all shipping labels face a barcode reader. The system 300 can also be used on an assembly line, for example, to rotate assemblies and/or turn corners.

While several possible embodiments are disclosed above and the system has been disclosed as a system for package handling, embodiments of the present invention are not so limited. For instance, while several possible configurations have been disclosed, other suitable materials and combinations of materials could be selected without departing from the spirit of embodiments of the invention. In addition, the location and configuration used for various features and components of embodiments of the present invention can be varied according to a particular application, assembly line, or manufacturing process that requires a slight variation due to, for example, surrounding machinery (e.g., on an assembly line), lifting requirements (e.g., on plane loading equipment) or other space and/or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced herein.

What is claimed is:

1. A drive system comprising:
a pair of drive chains, each chain comprising a first end and a second end;
a plurality of drive pulleys disposed at the first ends and the second ends of each drive chain for supporting and driving the drive chains; and
a plurality of rollers, each with a first end pivotally coupled to a first drive chain and a second end pivotally coupled to a second drive chain;
wherein the angle of the rollers with respect to the drive chains can be adjusted between a positive angle and a negative angle.

2. The system of claim 1, wherein each of the plurality of rollers further comprises:
a roller body; and
a roller axle disposed through the roller body at the axis of rotation.

3. The system of claim 2, wherein the roller axle further comprises one or more sockets for pivotally coupling the roller axle to the drive chains.

4. The system of claim 1, wherein the angle of the rollers can be adjusted between approximately −60 degrees and +60 degrees.

5. The system of claim 1, wherein the angle of the rollers can be adjusted between approximately −45 degrees and +45 degrees.

6. The system of claim 1, further comprising:
a roller brake with a first, engaged position and a second, disengaged position;
wherein in the engaged position, the rollers roll forward in the same direction as the drive chains; and
wherein in the disengaged position, the rollers can free wheel.

7. The system of claim 1, further comprising:
a first axle for mounting the drive pulleys on the first end of the drive chains; and
a second axle for mounting the drive pulleys on the second end of the drive chains.

8. The system of claim 1, further comprising one or more drive motors for driving one or more of the drive pulleys.

9. The system of claim 8, wherein the drive motors are reversible.

10. The system of claim 8, wherein the one or more drive motors are directly coupled to the first axle, the second axle, or both.

11. The system of claim 8, wherein the one or more drive motors are indirectly coupled to the first axle, the second axle, or both with a motor drive belt.

12. The system of claim 1, wherein the drive chains are belts.

13. The system of claim 1, further comprising a roller belt for changing the spin of the plurality of rollers.

14. A system for translating and rotating packages comprising:
an enclosure comprising at least a top surface; and
two or more drive systems each drive system comprising:
a pair of drive chains, each chain comprising a first end and a second end;
a plurality of drive pulleys disposed at the first ends and the second ends of each drive chain for supporting and driving the drive chains;
a plurality of rollers, each with a first end pivotally coupled to a first drive chain and a second end pivotally coupled to a second drive chain; and
one or more drive motors for driving the drive chains;
wherein the angle of the rollers with respect to the drive chains can be adjusted between a positive angle and a negative angle.

15. The system of claim 14, wherein the drive motors from each of the two or more drive system can be run in opposite directions at the same time.

16. The system of claim 14, wherein the drive pulleys are slip mounted on one or more axles to enable the phase between the drive chains to be adjusted.

17. The system of claim 16, wherein the phase between the drive chains determines the angle of the rollers.
